(19) United States
(12) Patent Application Publication
(10) Pub. No.: US 2016/0369101 A1
(43) Pub. Date: Dec. 22, 2016

(54) COMPOSITE MATERIAL AND MODULAR COVERING

(71) Applicant: GREENFIBER TECH, LDA., Porto (PT)

(72) Inventor: Jorge Viriato DE FREITAS BARROS DINIZ SANTOS, Porto (PT)

(73) Assignee: Greenfiber Tech, LDA., Porto (PT)

(21) Appl. No.: 15/111,403

(22) PCT Filed: Jan. 8, 2015
(86) PCT No.: PCT/IB2015/050146

§ 371 Date: Jul. 13, 2016

(30) Foreign Application Priority Data
Jan. 13, 2014 (PT) 107399
Sep. 15, 2014 (PT) 107885

(51) Int. Cl. C08L 97/00; B63B 5/24; B63B 3/48; E04F 15/02; E04F 15/10

(52) U.S. Cl. CPC C08L 97/007; E04F 15/02038; E04F 15/102; B63B 3/48; B63B 5/24

(57) ABSTRACT

This application describes a composite material, which can be used as modular covering for floors comprising a set of segments (1, 2) based on polymers, plant material and additives, coupled through a press fit coupling system, composed of a female part (3) with a concave shape, disposed at one of the ends of each of the segments (1, 2) and whose base has a cavity (4) with a greater width than the top, and a male part (5) at the opposite end of each of the segments (1, 2), whose base has a projection (6) to be coupled to the female part (3), in particular a cavity (4). During the coupling process, the female parts (3, 5) are subject to a controlled deformation, recovering their original shape to produce the fixing of the coupled segments (1, 2). This allows the fixing of the segments (1, 2) without recurrence to a fixing not included in the segment (1, 2) itself, avoiding the use of a fixing substructure, considering that the segments (1, 2) are applied to the surface to be covered.

### TECHNICAL FIELD

This application describes a composite material, which can be used as modular covering.

### PRIOR ART

It is known from prior art the use of wood or other natural fibres in composite materials, however, these solutions have some problems related not only to the limited thermal stability and the weak compatibility with the polymer, which affects the processing conditions, as also to the resistance towards humidity, UV, namely photodegradation, and to the biological agents, which conditions the final use.

Considering the limited thermal stability of natural fibres, there can only be used thermoplastics which melt and which can be processed at temperatures inferior to 200° C. One of the key aspects is the adhesion between natural fibres, which have a hydrophile character, and the polymer, which has a hydrophobe character. There have been used several strategies to increase the compatibility, as the application of surface treatments to the fibres to reduce their polar character or the modification of the polymers to increase its polarity. Another important aspect is the dispersion of the polymer in the fibres and also the runoff of the mixture, which can be improved by the addition of lubricants. The proportions of natural fibres and polymer will affect the physical and mechanical properties. Like this, the formulation of these products is crucial not only for processing, but also for the physical and mechanical performance and the durability of these products. The addition of additives allows to improve certain properties as the mechanical resistance, the light resistance, the fire resistance, the biologic durability, etc.

The document PT104704 discloses composites and biocomposites produced from different cork materials reinforced with natural or synthetic fibres, more specifically it refers to cork composites with synthetic, recycled or natural based polymers or its combinations, reinforced with natural and/or synthetic fibres, preferably using at least one binder. However, opposite to this application, it does not disclose or refer to any clue regarding a composite material using two different plant fibres simultaneously.

### SUMMARY

This application describes a composite material comprising a mixture of the following elements:
25% to 35% of polymeric material;
50% to 70% of plant material, comprising at least two different materials, one being cork;
0% to 15% of additives.

According to one embodiment, the composite material comprises 32% of polymeric material, 65% of natural fibres, which comprise 15% of wood and 50% of cork, and 3% of additives.

According to another embodiment, the polymeric material used in the composite material is polypropylene and/or polyvinyl chloride and/or polyethylene and/or high-density polyethylene and/or elastomers.

According to still another embodiment, the plant material used in the composite material is coconut fibre granulate and/or sisal fibre granulate and/or palm tree granulate and/or hemp fibre granulate.

According to one embodiment, the additives used in the composite material are binding agents and/or dyestuffs and/or UV stabilizers and/or impact modifiers and/or fire-resistance agents.

This application does also describe a modular covering produced in the composite material described above.

According to one embodiment, the modular covering comprises a set of segments coupled through a coupling system.

According to another embodiment, the coupling system of the modular covering is a press fit type coupling system, composed of a female part with a concave shape, disposed at one of the ends of each of the segments and whose base has a cavity with a greater width than the top, and a male part at the opposite end of each of the segments, whose base has a projection to be coupled to the female part.

According to still another embodiment, each of the segments of the modular covering comprises a runoff opening on its inferior side.

According to one embodiment, each of the segments of the modular covering comprises support battens.

According to another embodiment, the modular covering of the modular covering comprises oblique channels.

According to still another embodiment, the modular covering of the modular covering comprises at least one aeration bore.

According to one embodiment, the set of segments of the modular covering comprises a programmed deformation zone.

According to another embodiment, the programmed deformation zone of the modular covering is included in all the interaction zones between the segments and the floor.

According to still another embodiment, the programmed deformation zone of the modular covering is developed from a thermoplastic elastomer.

According to one embodiment, the programmed deformation zone of the modular covering is developed from thermoplastic elastomers based on hydrogenated styrene block copolymers.

According to one embodiment, the elements which compose the coupling system of the modular covering are obtained by extrusion or by injection.

Finally, this application does also describe the use of the modular covering in the construction of surfaces for outer areas, in particular in building and in shipbuilding construction.

### BRIEF DESCRIPTION OF THE DRAWINGS

For an easier comprehension of this invention there are drawings attached hereto, which represent preferred embodiments of the invention, but which do not intend to limit the scope of this invention.

FIG. 1: Profile representation of the segments and the coupling system wherein the following numbers represent:
1 and 2—Segment;
3—Female part;
4—Cavity;
5—Male part;
6—Projection.

FIG. 2: Underneath view of the segments and of the coupling system wherein the following numbers represent:
1 and 2—Segment;
3—Female part;
5—Male part;
7—Runoff opening.

FIG. 3: Profile representation of the segments and of the coupling system wherein the following numbers represent:
1 and 2—Segment;
3—Female part;
4—Cavity;
5—Male part;
6—Projection;
8—Support battens.

FIG. 4: Profile representation of the segments and of the coupling system and of the deformation zones wherein the following numbers represent:
3—Female part;
5—Male part.

FIG. 5: Representation of the segments and of the coupling system in a square shape wherein the following numbers represent:
3—Female part;
9, 10—Square-shaped segments.

FIG. 6: Representation of the segments of the modular covering.

FIG. 7: Representation of the segments of the modular covering.

FIG. 8: Representation of the aeration bore in the modular covering wherein the following numbers represent:
11—Aeration bore.

FIG. 9: Profile representation of the segments and of the coupling system with programmed deformation zone, wherein the following numbers represent:
12—Programmed deformation zone.

FIG. 10: Profile representation of the segments and of the coupling system of the modular covering.

### DESCRIPTION OF THE EMBODIMENTS This application describes a composite material, which can

be used as modular covering for floors used in the construction of surfaces for outer areas, in particular in building and in shipbuilding construction.

Table I presents the preferential components and values using three categories of materials, polymers, plant material and additives.

TABLE I
Preferential components

| | | |
|---|---|---|
| Polymers-25% to 35% | Plant material-50% to 70% | Additives-0% to 15% |
| Polypropylene (PP) | Cork granulate | Binding agents |
| Polyvinyl chloride | Coconut fibre | Dyestuffs |
| (PVC) | granulate (fruit, | |
| | leaves, branches and | |
| | trunk) | |
| Polyethylene (PE) | Sisal fibre granulate | UV Stabilizers |
| High-density | Palm tree granulate | Impact modifiers |
| polyethylene (HDPE) | (fruit, leaves, | |
| | branches and trunk) | |
| Elastomers | Hemp fibre granulate | Fire-resistance agents |

The composite material can be obtained through the combination of the base materials mentioned above, in a cumulative way, with one or more polymers, combined with one or more additives and with one or more plant materials, or, alternatively, using just one polymer, one type of additive and at least two plant materials. From these combinations the use of additives can be excluded from the composite material. The shape of the coupling and/or fixing system can be modified to allow its production by several production methods, as for example extrusion, mould injection and even pressing to obtain the flat shaped parts.

The use of cork has lots of advantages compared to conventional natural fibres, namely wood, bamboo, sisal, hemp, etc., considering the properties conferred to it by its cellular structure and chemical composition, namely a low water permeability, a low thermal conductivity, a notable chemical and biological stability, a good durability in outer areas and a good fire resistance. This option presents specific mechanical properties as its viscous elasticity, super compressibility without fracture and dimensional recovery capacity. It is an anti-vibration material and a good thermal and acoustic insulator, presenting an excellent stability, even when subject to high thermal variations. Furthermore, compared to wood which has a hydrophile character, due to its main chemical component, suberin, cork presents an increased affinity towards apolar liquids as thermoplastics. Furthermore, its cellular structure allows a better binding with the other elements of the composite material. This way, through its use together with a polymer combined with an adequate compatibility agent, there are obtained:
better humidity resistance;
smaller water absorption;
smaller amount of additives and polymer;
smaller weight per length unit of the final product.

In the case of its application in a modular covering for floors, the covering presents a set of segments (1, 2), based on a mixture of polymers, plant material and additives, coupled through a press fit coupling system, composed of a female part (3) with a concave shape, disposed at one of the ends of each of the segments (1, 2) and whose base has a cavity (4) with a greater width than the top, and a male part (5) at the opposite end of each of the segments (1, 2), whose base has a projection (6) to be coupled to the female part (3), in particular a cavity (4).

The elements composing this press fit coupling system can be obtained through any adequate production process, as for example by extrusion, by injection or other.

This modular covering can comprise a set of segments (1, 2) with a programmed deformation zone in all the interaction zones between these segments and the floor where this modular covering will be applied, as shown in FIG. 9. This programmed deformation zone should be developed with a shock absorbing material, as any polymeric material considered to be more soft than the polymeric material used in the construction of the segments (1, 2). This programmed deformation zone has the goal to absorb small irregularities which might occur on the floor assuring that the covering remains completely regular and without occurrence of any noise due to walking.

The programmed deformation zone is developed with a more soft shock absorbing material than the polymeric material used in the construction of the segments (1, 2), as for example a thermoplastic elastomer. Preferably there should be used thermoplastic elastomers based on hydrogenated styrene block copolymers.

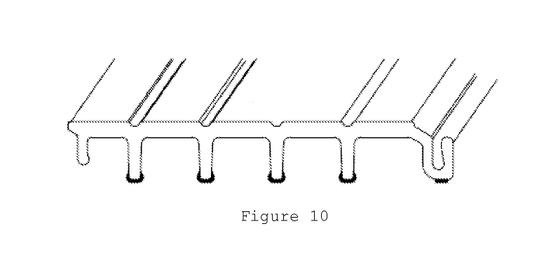

During the coupling process, the female parts (3, 5) are subject to a controlled deformation, recovering their original shape to produce the fixing of the coupled segments (1, 2). Each of the segments (2, 3) can be composed, on its inferior side, of a runoff opening (7) and of several support battens (8) which allow the formation of channels for the water runoff in the longitudinal and perpendicular direction in relation to the segment. According to an additional embodiment, the segments (2, 3) can have an oblique radius for the adequate water runoff, as shown in FIG. 10. In the case of the support battens (7) they do additionally allow the support of each segment and its contact with the surface to be covered. The coupling described above allows the fixing of the segments (1, 2) without recurrence to external fitting parts not included in the segment (1, 2) itself, avoiding the use of a fixing substructure, which represents a saving of raw material.

The coupling system described above is possible due to the elasticity and flexibility characteristics of the used polymer, plant material and additives based material allowing, in particular, the controlled deformation of the parts (3, 5), during the fitting process, namely the cavity (4), to assure a secure fitting and the coupling of the segments (1, 2). FIG. 4 illustrates the points which are subject to a greater flexibility, indicated by the lighter coloured zones, during the fitting process.

The coupling system can also be introduced in parts of different shapes and with the desired reception and insertion points (two by two), as illustrated in FIG. 5. In this case, the segments (9, 10) are also different considering that they do not need support battens (8), its preferential use being in places where the water runoff is not so intense.

### APPLICATION EXAMPLES

In the following there will be presented an application example of the technology presented above, which however does not intend to limit the scope of protection of this application.

The modular covering for floors can be developed in a composite material consisting of 32% of polymeric material, for example polypropylene (PP), 65% of natural fibres, which comprise for example approximately 15% of wood and 50% of cork, and 3% of additives.

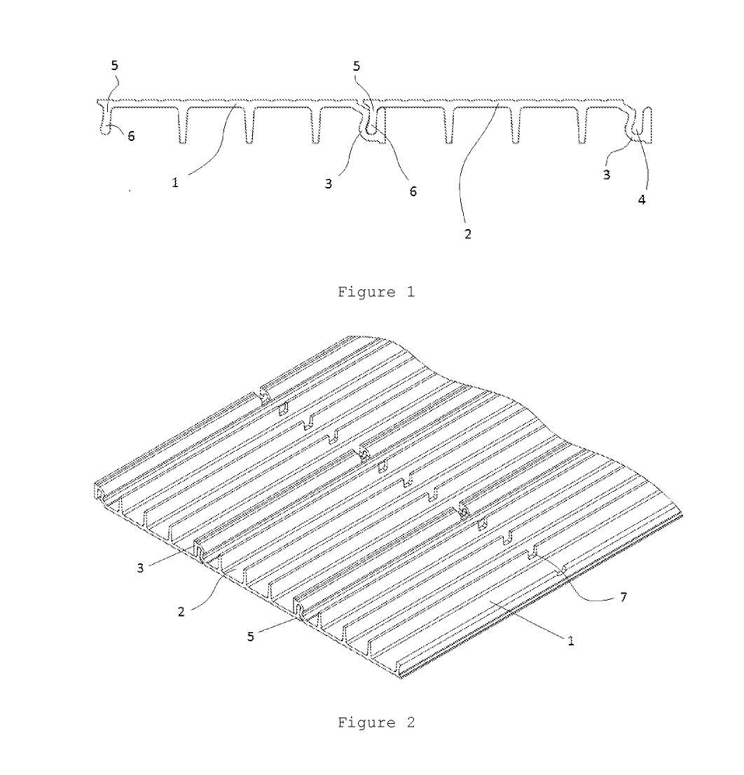

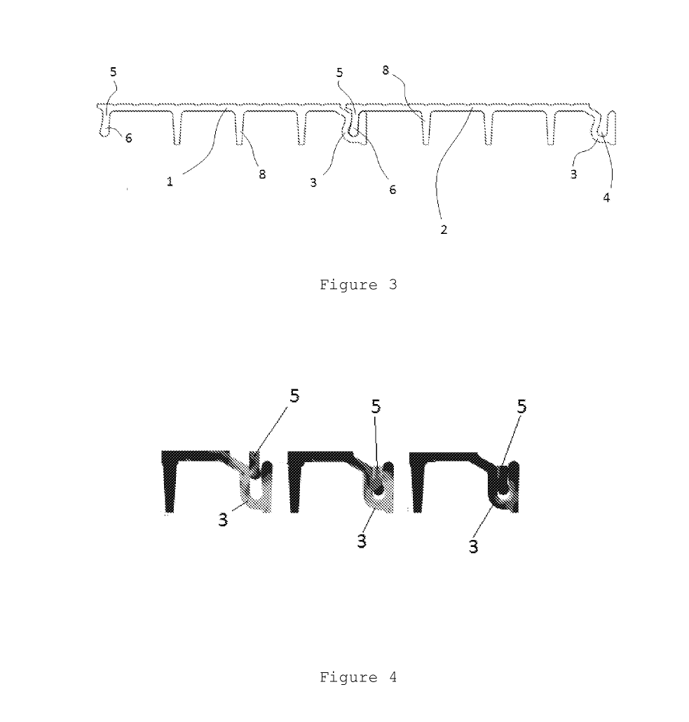

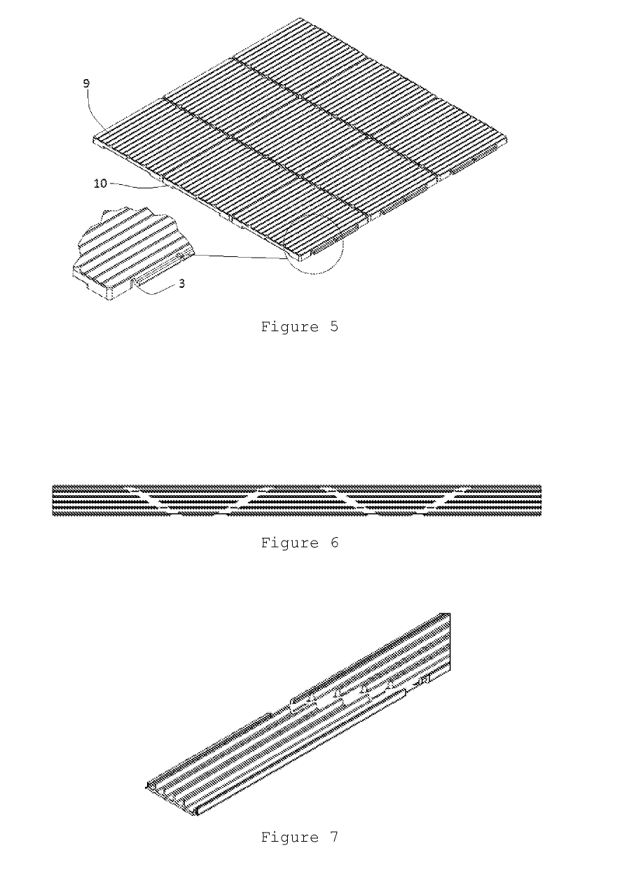

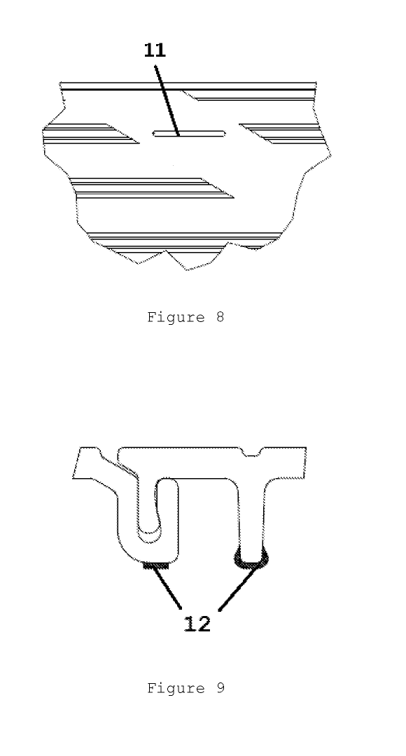

The modular covering can be developed by any obtaining method. After its development, the covering can comprise oblique channels, as illustrated in FIGS. 6 and 7. These oblique channels are of extreme importance to obtain hydraulic runoff in at least two directions.

The modular covering can also comprise at least one aeration bore (11), as illustrated in FIG. 8, which has the goal to reduce the probability of occurrence of fungus, among other problems which might reduce the lifetime of the mentioned covering.

This embodiment is not, in any way, restricted to the embodiments described in this document and a person averagely skilled in the art might predict lots of modification possibilities of the same without leaving the general idea, as defined in the claims.

Preferred embodiments described above can obviously be combined amongst each other. The following claims do additionally define preferred embodiments.

1. Modular covering comprising a composite material, which comprises a mixture of the following elements:
25% to 35% of polymeric material, which is polypropylene and/or polyvinyl chloride and/or polyethylene and/or high-density polyethylene and/or elastomers;
50% to 70% of plant material, which is coconut fibre granulate and/or sisal fibre granulate and/or palm tree granulate and/or hemp fibre granulate, comprising at least two different materials, one being cork;
0% to 15% of additives.

2. Modular covering according to claim 1, wherein the composite material comprises 32% of polymeric material, 65% of natural fibres, which comprise 15% of wood and 50% of cork, and 3% of additives.

3. Modular covering according to claim 1, wherein the additives used in the composite material are binding agents and/or dyestuffs and/or UV stabilizers and/or impact modifiers and/or fire-resistance agents.

4. Modular covering according to claim 1, comprising a set of segments coupled through a coupling system.

5. Modular covering according to claim 4, wherein the coupling system is a press fit type coupling system, composed of a female part with a concave shape, disposed at one of the ends of each of the segments and whose base has a cavity with a greater width than the top, and a male part at the opposite end of each of the segments, whose base has a projection to be coupled to the female part.

6. Modular covering according to claim 4, wherein each of the segments comprises a runoff opening on its inferior side.

7. Modular covering according to claim 4, wherein each of the segments comprises support battens.

8. Modular covering according to claim 4, comprising oblique channels.

9. Modular covering according to claim 4, comprising at least one aeration bore.

10. Modular covering according to claim 4, wherein a set of segments (1, 2) comprises a programmed deformation zone.

11. Modular covering according to claim 13, wherein the programmed deformation zone is included in all the interaction zones between the segments (1, 2) and the floor.

12. Modular covering according to claim 10, wherein the programmed deformation zone is developed from a thermoplastic elastomer.

13. Modular covering according to claim 10, wherein the programmed deformation zone is developed from thermoplastic elastomers based on hydrogenated styrene block copolymers.

14. Modular covering according to claim 4, wherein the elements which compose the coupling system are obtained by extrusion or by injection.

15. Use of the modular covering described in claim 1 in the construction of surfaces for outer areas, in particular in building and shipbuilding construction.
